(19) United States
(12) Patent Application Publication
(10) Pub. No.: US 2026/0112177 A1
(43) Pub. Date: Apr. 23, 2026

(54) VEHICLE DASHCAM WITH DUAL FRONT-FACING CAMERAS

(71) Applicant: MOTIVE TECHNOLOGIES, INC., San Francisco, CA (US)

(72) Inventors: Gautam KUNAPULI, Brooklyn, NY (US); Scott Alan MORFORD, Dakota Dunes, SD (US); Kartik AIYER, Santa Clara, CA (US); Amish Rajesh BABU, Los Altos, CA (US); Victor CHEN, Taipei (TW); George Winchester CRUM, III, Arlington, VA (US); Joseph Norman PULVER, Tonawanda, NY (US)

(21) Appl. No.: 18/922,827

(22) Filed: Oct. 22, 2024

(51) Int. Cl. G06V 20/58; G06F 3/01; G06V 20/40; G06V 20/62

(52) U.S. Cl. CPC G06V 20/58; G06F 3/017; G06V 20/44; G06V 20/625; G06V 2201/07

(57) ABSTRACT

The techniques described herein relate to a system comprising dual camera sensors and a controller. The first camera sensor captures a wide-field view in front of a vehicle, while the second camera sensor captures a near-field view, with both sensors recording images simultaneously. The controller includes a processing unit and multiple machine learning models. The first model processes images from the wide-field camera to detect objects, while the second model analyzes near-field camera images for object detection. A machine learning pipeline receives detection data from both models and sends corresponding instructions to the processing unit. The system leverages both wide and near-field perspectives to maintain comprehensive awareness of the vehicle's surroundings through parallel object detection streams. The unified pipeline integrates these detections to inform the controller's decision-making and subsequent vehicle instructions.

### BACKGROUND

Vehicle dashcams can be used to provide enhanced functionality and safety features to drivers and fleet managers. Current dashcam designs generally rely on a single camera to capture images exterior to a vehicle. Such approaches result in increased computational complexity and power usage that limit the effectiveness of such devices.

### BRIEF DESCRIPTION OF THE FIGURES

FIG. 1 is a block diagram illustrating a dashcam according to some of the disclosed embodiments.

FIG. 2 is a flow diagram illustrating a method for performing object detection using multiple front-facing cameras according to some of the disclosed embodiments.

FIG. 3 is a flow diagram illustrating an alternative method for performing object detection using multiple front-facing cameras according to some of the disclosed embodiments.

FIG. 4 is a flow diagram illustrating a method for utilizing a network of dashcams to locate vehicles or persons of interest and track historical vehicle locations according to some of the disclosed embodiments.

FIG. 5 is a flow diagram illustrating a method for leveraging an interconnected dashcam network to expand situational awareness and context around events of interest according to some of the disclosed embodiments.

FIG. 6 is a diagram illustrating the combination of wide and narrow field of view video streams into a single composite view to enhance the user experience when reviewing captured footage according to some of the disclosed embodiments.

FIG. 7 is a flow diagram illustrating a method for utilizing the dashcam system to provide analytics and real-time monitoring for fleet management applications according to some of the disclosed embodiments.

FIG. 8 is a flow diagram illustrating a method for processing voice commands in a dashcam system according to some of the disclosed embodiments.

FIG. 9 is a flow diagram illustrating a method for processing gesture commands in a dashcam system using a gesture recognition model according to some of the disclosed embodiments.

FIG. 10 is a flow diagram illustrating a method for enabling communication and collaboration between multiple dashcam systems using a mesh network according to some of the disclosed embodiments.

FIG. 11 is a block diagram of a computing device according to some embodiments of the disclosure.

### DETAILED DESCRIPTION

In some implementations, the techniques described herein relate to a system including: a first camera sensor, the first camera sensor capturing a wide-field of view in front of a vehicle; a second camera sensor, the second camera sensor capturing a near-field of view in front of the vehicle, wherein the first camera sensor and the second camera sensor are configured to simultaneously record images in front of the vehicle; a controller, the controller including: a processing unit, a plurality of machine learning models, wherein a first machine learning model in the plurality of machine learning models is configured to receive a first set of image frames from the first camera sensor and detect a first detection of a first set of objects or image segments, their attributes or descriptions, and relationships between them within the first set of image frames, and wherein a second machine learning model in the plurality of machine learning models is configured to receive a second set of image frames from the second camera sensor and detect a second detection of a second set of objects or image segments, their attributes or descriptions, and relationships between them within the second image frame, and a machine learning pipeline configured to receive the first detection and the second detection and transmit an instruction to the processing unit based on the first detection and second detection.

In some implementations, the techniques described herein relate to a system, wherein the first detection of the first object includes a detection of a license plate.

In some implementations, the techniques described herein relate to a system, wherein the second detection of the second object includes an identification of alphanumeric characters on the license plate.

In some implementations, the techniques described herein relate to a system, wherein the first machine learning model and the second machine learning model are executed independently.

In some implementations, the techniques described herein relate to a system, wherein the machine learning pipeline is configured to execute the second machine learning model after detecting the first detection.

In some implementations, the techniques described herein relate to a system, wherein the machine learning pipeline is configured to provide location information to the second machine learning model when providing the second image frame to the second machine learning model.

In some implementations, the techniques described herein relate to a system, wherein the machine learning pipeline is configured to input the first detection and second detection into a third machine learning model to detect an event.

In some implementations, the techniques described herein relate to a system, further including an inward-facing camera communicatively coupled to the controller, wherein the controller is configured to execute an inward machine learning model, the inward machine learning model configured to receive third image frames from the inward-facing camera and detect a gesture occurring within the third image frames, wherein the controller is configured to transmit a second instruction to the processing unit based on a type of the gesture.

In some implementations, the techniques described herein relate to a system, further including a microphone configured to record audio samples within the vehicle, wherein the controller is configured to execute voice model to reduce noise within the audio samples and detect a spoken command within the audio samples, wherein the controller is configured to transmit a third instruction to the processing unit based on the spoken command.

In some implementations, the techniques described herein relate to a system, further including a wireless network interface, wherein the controller is configured to establish a mesh network with at least one other dashcam using the wireless network interface.

In some implementations, the techniques described herein relate to a method including: receiving, at a first machine learning model, a first image frame from a first camera sensor, the first camera sensor capturing a wide-field of view in front of a vehicle; receiving, at a second machine learning model, a second image frame from a second camera sensor, the second camera sensor capturing a near-field of view in front of the vehicle, wherein the first image frame and the second image frame are captured simultaneously; detecting, using the first machine learning model, a first object within the first image frame; detecting, using the second machine learning model, a second object within the second image frame; and transmitting, using a machine learning pipeline, an instruction to a processing unit based on detecting the first object and the second object.

In some implementations, the techniques described herein relate to a method, wherein detecting the first object includes detecting a license plate within the first image frame, and wherein detecting the second object includes identifying alphanumeric characters on the license plate within the second image frame.

In some implementations, the techniques described herein relate to a method, further including executing the first machine learning model and the second machine learning model independently; and executing, using the machine learning pipeline, the second machine learning model after detecting the first object within the first image frame.

In some implementations, the techniques described herein relate to a method, further including providing, using the machine learning pipeline, location information of the first object to the second machine learning model when providing the second image frame to the second machine learning model.

In some implementations, the techniques described herein relate to a method, further including inputting, using the machine learning pipeline, a detection of the first object and a detection of the second object into a third machine learning model; and detecting, using the third machine learning model, an event based on the detection of the first object and the detection of the second object.

In some implementations, the techniques described herein relate to a non-transitory computer-readable storage medium for tangibly storing computer program instructions capable of being executed by a computer processor, the computer program instructions defining steps of: receiving, at a first machine learning model, a first image frame from a first camera sensor, the first camera sensor capturing a wide-field of view in front of a vehicle; receiving, at a second machine learning model, a second image frame from a second camera sensor, the second camera sensor capturing a near-field of view in front of the vehicle, wherein the first image frame and the second image frame are captured simultaneously; detecting, using the first machine learning model, a first object within the first image frame; detecting, using the second machine learning model, a second object within the second image frame; and transmitting, using a machine learning pipeline, an instruction to a processing unit based on detecting the first object and the second object.

In some implementations, the techniques described herein relate to a non-transitory computer-readable storage medium, wherein detecting the first object includes detecting a license plate within the first image frame, and wherein detecting the second object includes identifying alphanumeric characters on the license plate within the second image frame.

In some implementations, the techniques described herein relate to a non-transitory computer-readable storage medium, further including executing the first machine learning model and the second machine learning model independently; and executing, using the machine learning pipeline, the second machine learning model after detecting the first object within the first image frame.

In some implementations, the techniques described herein relate to a non-transitory computer-readable storage medium, further including providing, using the machine learning pipeline, location information of the first object to the second machine learning model when providing the second image frame to the second machine learning model.

In some implementations, the techniques described herein relate to a non-transitory computer-readable storage medium, further including inputting, using the machine learning pipeline, a detection of the first object and a detection of the second object into a third machine learning model; and detecting, using the third machine learning model, an event based on the detection of the first object and the detection of the second object.

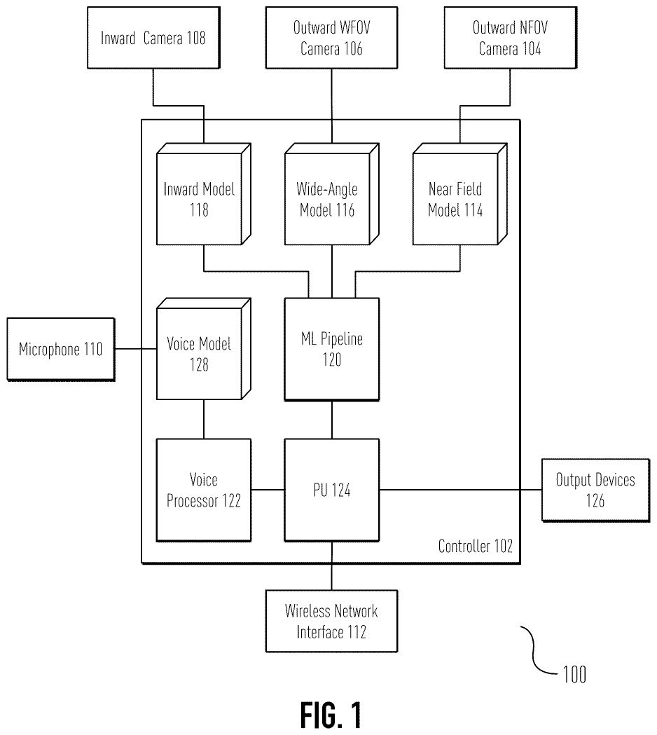

FIG. 1 is a block diagram illustrating a dashcam according to some of the disclosed embodiments.

In the illustrated embodiment, a dashcam (100) includes a controller (102). The controller (102) is communicatively coupled to peripheral devices including, without limitation, a near-field outward camera (104), a wide-field outward camera (106), an inward camera (108), a microphone (110), and a wireless network interface (112). As illustrated, the controller (102) includes a processing unit (124) which may comprise a general purpose central processing unit, a graphics processing unit, or similar units or combinations thereof. Certainly, additional peripherals may be onboard dashcam (100) and the disclosure is not limited to only the illustrated peripherals. In some implementations, dashcam (100) may be mounted on the interior of a vehicle. For example, dashcam (100) may be mounted on the windshield of a vehicle (e.g., center top) or may be mounted on the dash of the vehicle.

Controller (102) receives data from and sends data to the various peripherals and performs data processing operations thereon. Controller (102) may perform numerous functions not described herein and only a subset of those operations are described in detail in the disclosure. As such, the operations of controller (102) are not limited to those described herein.

As illustrated, controller (102) may execute various machine learning models including near-field model (114), wide-angle model (116), and inward model (118). Certainly, more, or fewer, models may be executed on dashcam (100) and more or fewer models can be executed on the output of any one camera. In some implementations, machine learning models may be trained at a central processing location (not illustrated) and the model parameters may be stored locally on dashcam (100) in, for example, a local memory (not illustrated). In some implementations, controller (102) can execute a machine learning model by loading its model parameters and inserting data into the models to obtain a predictive output value. Specific details on how to load and execute machine learning models is not described in detail herein and any suitable technique to do so may be used. Various models are described next in a non-limiting manner.

Controller (102) may execute a near-field model (114). In some implementations, near-field model (114) receives image frames from near-field outward camera (104). As one example, near-field model (114) may comprise a convolutional neural network configured to detect a pre-defined set of object types within image frames captured by the near-field outward camera (104). Controller (102) may further execute a wide-angle model (116). In some implementations, wide-angle model (116) receives image frames from wide-field outward camera (106). As one example, wide-angle model (116) may comprise a convolutional neural network configured to detect a pre-defined set of object types within image frames captured by the wide-field outward camera (106). Finally, controller (102) may execute an inward model (118). In some implementations, inward model (118) receives image frames from inward camera (108). As one example, inward model (118) may comprise a neural network such as a CNN, transformer model, etc. configured to detect a pre-defined set of object types within image frames captured by the inward camera (108).

As described, each of the models may be configured to detect objects, although other models or ensemble models can be used. In some implementations, the machine learning models are configured to perform a range of fundamental perception tasks. These tasks may include, but are not limited to object detection, classification, segmentation, and depth and distance estimation. In some implementations, object detection refers to a machine learning task that can identify and localize objects of interest within the image frames. This may involve determining the presence and spatial location of specific objects, such as vehicles, pedestrians, traffic signs, or other relevant elements in the vehicle's environment. In some implementations, classification refers to a machine learning task that can categorize them into predefined classes. For example, a detected vehicle may be classified as a car, truck, motorcycle, or other vehicle type. This classification capability enables the system to understand the nature of the objects in its environment. In some implementations, segmentation refers to a machine learning task that can precisely delineate the boundaries of objects or regions within the image frames. This may include instance segmentation, where individual objects are outlined, or semantic segmentation, where regions of the image are categorized (e.g., road surface, sidewalk, building). Segmentation provides a detailed understanding of the spatial layout of the scene. In some implementations, depth and distance estimation refers to a machine learning task that can determine the distance of detected objects from the camera. This may be achieved through various techniques, such as stereo vision using the two camera sensors, monocular depth estimation, or a combination of visual and other sensor data. Accurate depth estimation is crucial for understanding the three-dimensional structure of the environment. By combining these fundamental perception tasks, the system can build a comprehensive understanding of the vehicle's environment. This multi-faceted perception enables advanced functionalities such as obstacle avoidance, path planning, and situation awareness, thereby enhancing the overall safety and effectiveness of the vehicle operation.

As will be discussed in more detail herein, wide-angle model (116) and near-field model (114) may be utilized to detect the same classes of objects, albeit at different perspectives due to the nature of the cameras generating images. Specifically, wide-field outward camera (106) may comprise a camera sensor that captures a wide-angle, outward facing view from the front perspective of a vehicle. As such, wide-field outward camera (106) will generally capture more of the periphery of forward-facing view of a vehicle albeit at a lower resolution. By contrast, near-field outward camera (104) will capture a more focused and narrowed view of the forward-facing view of a vehicle at a higher resolution. In general, both the wide-angle model (116) and near-field model (114) can be synchronized to generate predictive outputs at the same time. That is, at a given time step (t), both wide-field outward camera (106) and near-field outward camera (104) will capture an image and pass the image to their corresponding models for prediction. As will be discussed, in some implementations, the results can be used by a machine learning pipeline (120) for downstream applications based on the detected objects (e.g., license plates). In some implementations, the machine learning pipeline (120) may comprise a dedicated machine learning processor such as a graphics processing unit, system-on-a-chip, artificial intelligence edge processor, or similar device. Although the figure illustrates three cameras, additional cameras may be present on the vehicle, either inward or outward facing, and at any location of the vehicle. Further, such cameras may be either wide-field or near-field (or a combination of both) as needed.

In combination with wide-field outward camera (106) and near-field outward camera (104), the dashcam (100) can include an inward camera (108). In some implementations, inward camera (108) can comprise either a wide-angle or near-field camera. In general, inward camera (108) is pointed inward, into the interior of a vehicle and can capture image frames of the interior. In some implementations, inward model (118) can be configured to process these image frames and detect events (e.g., gestures, drowsiness, etc.) as well as other objects (e.g., mobile phones, food items, etc.). In some implementations, inward model (118) can perform object detection, pose estimation, facial recognition, and other similar predictions. In general, inward model (118) may operate independent of wide-field outward camera (106) and near-field outward camera (104). However, as will be discussed, in some implementations, machine learning pipeline (120) may combine the predictions of inward model (118) with predictions of wide-angle model (116) or near-field model (114) to perform additional predictions.

In the illustrated implementation, the various models can predict outputs and provide these productions to a machine learning pipeline (120). In some implementations, machine learning pipeline (120) can comprise a series of operations perform on the various model outputs generated by dashcam (100) models. In some implementations, machine learning pipeline (120) may apply operations solely on the outputs of the models. In other scenarios, machine learning pipeline (120) can orchestrate operations of the models. For example, machine learning pipeline (120) can receive an image classification from an outward camera of a lane change event and receive a classification of the interior of the vehicle indicating a drowsy driver and determine that a driver is falling asleep and is losing control of the vehicle. As illustrated in this example, the combination of two predictions can be used to predict a new event. Certainly, lane changes may occur when a driver is not drowsy, thus the combination of predictive outputs can provide enhanced understanding of events. As another example, machine learning pipeline (120) can receive a first prediction from wide-angle model (116) that one or more license plates were detected. However, the wide-angle model (116) may not be capable of capturing the text of the license plates due to the reduced resolution. Thus, the machine learning pipeline (120) may execute the near-field model (114) on the near-field images which are of higher resolution to perform license plate recognition. Since the near-field model (114) may consume more processing resources, such an orchestration approach can reduce the number of operations performed by the near-field model (114) by performing an initial detection using the wide-angle model (116).

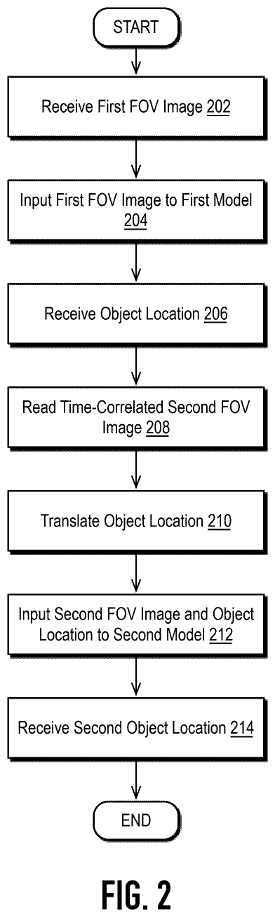

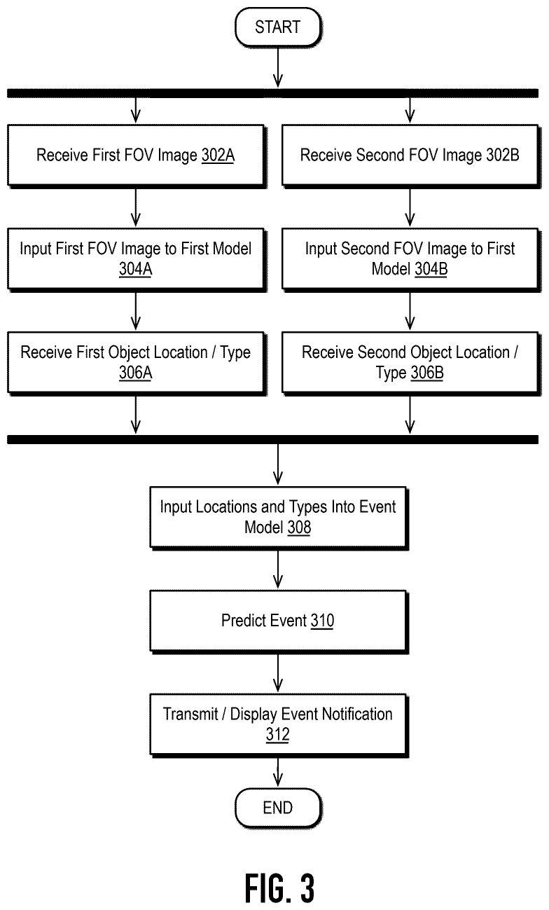

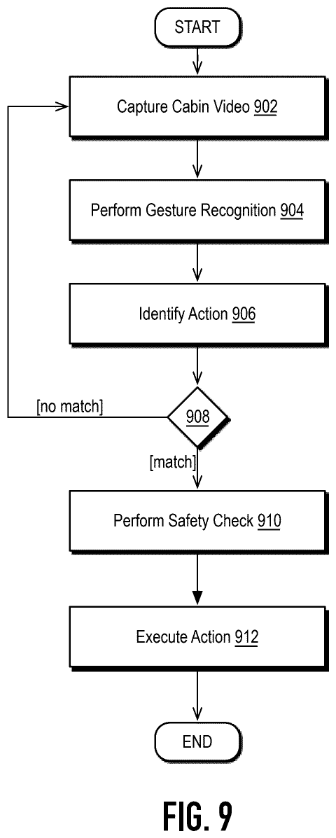

Various operations involving machine learning pipeline (120) are described more fully in the following flow diagrams and those details are not described in detail herein. Specifically, FIGS. 2 and 3 describe operations to combine predictions from multiple cameras and FIG. 9 provides an example scenario of performing gesture detection with optional safety checks. Details of these figures are not repeated herein.

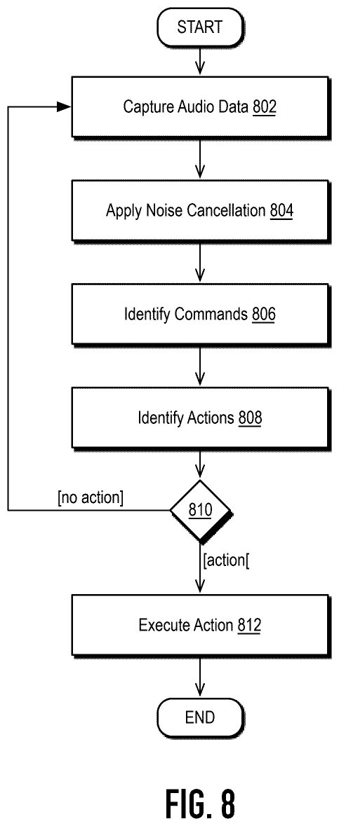

In the illustrated embodiment, dashcam (100) can include a microphone (110). In some implementations, microphone (110) can be used to record audio within a vehicle. In some implementations, microphone (110) can continuously record audio samples and transmit those audio samples to a voice model (128). In some implementations, voice model (128) can comprise a machine learning model configured to detect commands (e.g., text) within audio samples. In some implementations, voice model (128) can transmit a stream of tokens or text to a voice processor (122) which can convert detected commands into commands to issue to processing unit (124). For example, voice model (128) can receive an audio sample from microphone (110) and detect the text “upload recording.” Voice model (128) can provide this text to voice processor (122) which may store a mapping of text to commands executable by processing unit (124) which may, in turn, execute the corresponding command. In some implementations, voice model (128) can be equipped with a pre-processor to pre-process audio samples prior to classification. Specifically, voice model (128) may include an in-cabin noise cancellation filter to reduce the level of ambient or background noise in the audio samples. In some implementations, this noise cancellation filter may comprise a bandpass filter or similar type of filter. In other implementations, this noise cancellation filter can comprise its own machine learning model to convert noisy audio samples into clean audio samples. In some implementations, this machine learning model can be trained using actual labeled recordings within a vehicle. In some implementations, the voice model (128) can be vehicle-specific. That is, a given make and/or model of vehicle can be supplied with a noise cancellation filter that is tuned to the acoustics of the make/model, thus improving the accuracy of the model. Further details on the processing of voice commands are provided in the description of FIG. 8, which are not repeated herein.

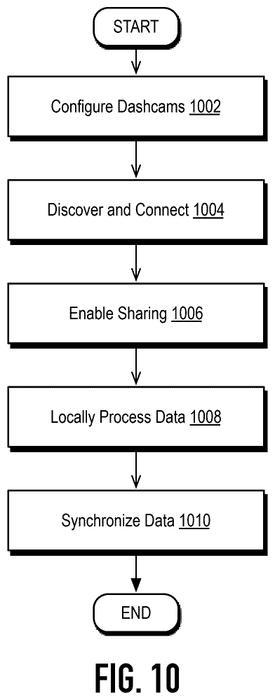

In the illustrated embodiment, dashcam (100) further includes a wireless network interface (112). In some implementations, wireless network interface (112) can comprise an IEEE 802.11 interface, or similar suitable interface. In some implementations, processing unit (124) can operate wireless network interface (112) to generate a mesh wireless network with one or more other dashcams (not illustrated) implemented as depicted in FIG. 1. Further details on establishing a mesh network are provided in the description of FIG. 10, which are not repeated herein. In some implementations, wireless network interface (112) can further be used to transmit data to other dashcams (not illustrated) or to other remote computing devices (not illustrated). In some implementations, wireless network interface (112) may include multiple interfaces including, without limitation, a cellular interface, satellite interface, or multiple redundant interfaces. In some implementations, processing unit (124) may be configured to transmit data to other devices based on the operation of machine learning pipeline (120), voice processor (122) and other sub-components. For example, upon detecting a license plate, the machine learning pipeline (120) may issue an instruction to the processing unit (124) that includes the license plate details. In response, the processing unit (124) may transmit a network message to a remote computing system to report the detected license plate. Alternatively, or in conjunction with the foregoing, the processing unit (124) may generate a command to transmit the detected license plate to other dashcams to enable a surveillance function. Similarly, the voice processor (122) may transmit an instruction identified based on a spoken command to the processing unit (124). The processing unit (124) may then execute a command to act based on the instruction. Various details of these operations are described in more detail herein.

In the illustrated embodiment, dashcam (100) further includes one or more output devices (126). In some implementations, output devices (126) can comprise audio output devices (e.g., speakers), visual output devices (e.g., screens), haptic output devices, or similar types of output devices. Processing unit (124) may output signals to output devices (126) based on the foregoing processing. For example, in response to detecting a drowsiness event, captured via inward camera (108), processing unit (124) may play an audio sound via output devices (126). Various other output operations are possible, and the disclosure is not limited herein.

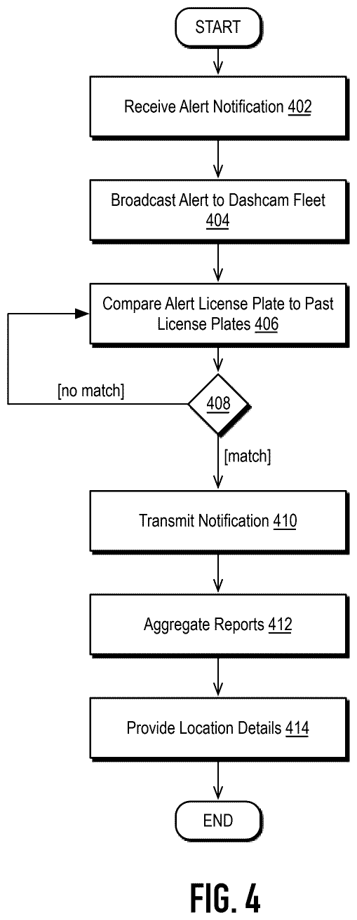

In some implementations, a system with vehicles each equipped with a dashcam (100) can provide various surveillance and tracking applications by virtue of its ability to capture and analyze video from multiple vehicles spread across a wide area. For example, the system could be used to rapidly locate vehicles or persons of interest, such as in response to an Amber Alert, by scanning for a specific license plate captured by any of the dashcams in the network. The system could also track the historical locations of specific vehicles of interest by leveraging the saved metadata and imagery from the dashcam network. Further details of this scenario are provided in the description of FIG. 4 which is not repeated herein.

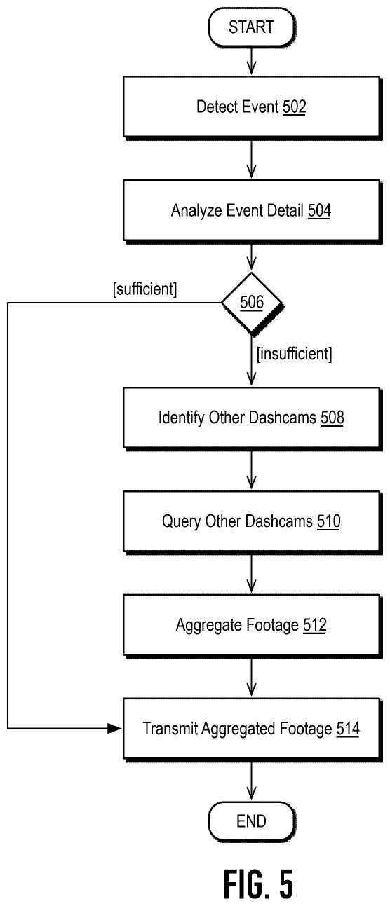

Further, in some implementations, an interconnected dashcam network enables a novel approach to expanding situational awareness and context around events of interest. For example, if a particular dashcam was unable to capture the details of an accident due to damage or obstruction, the system could query other dashcams in the vicinity at that time to see if they captured relevant footage of the scene. This could provide valuable contextual information for insurance claims or accident investigations. The network could also enable notification of road hazards or traffic conditions detected by one vehicle to other vehicles in the vicinity. Further details of this scenario are provided in the description of FIG. 5 which is not repeated herein.

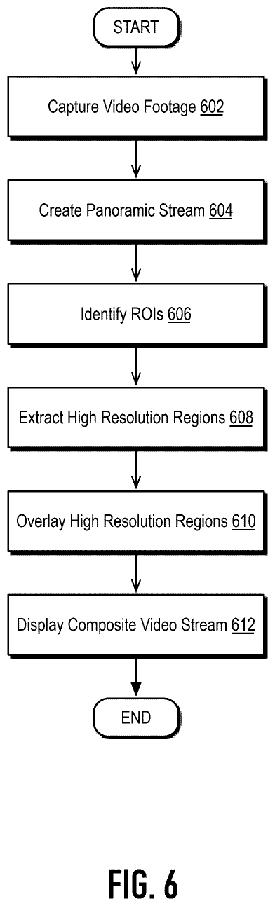

Further, the ability to seamlessly combine the wide and narrow field of view video streams into a single composite view provides an enhanced user experience for reviewing the captured footage. By stitching together, the wide field of view video with a high resolution inset region from the narrow field of view camera, users can appreciate both the full situational context and high definition details in a single view. This feature helps alleviate the tradeoff between coverage area and video resolution. Further details of this scenario are provided in the description of FIG. 6 which is not repeated herein.

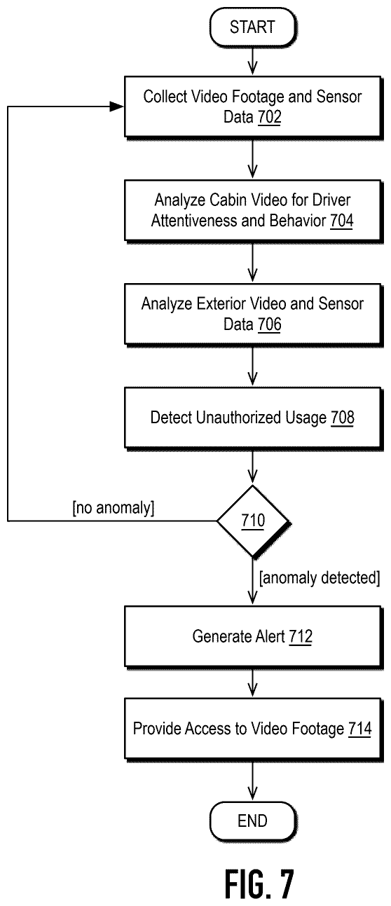

The dashcam system can also provide useful analytics and real-time monitoring for fleet management applications. For example, the inward-facing camera can be used to monitor driver attentiveness and behavior, while the outward-facing cameras can track route adherence and driving patterns. The system could even provide alerts for unauthorized usage or suspicious after-hours activity of fleet vehicles based on license plate detection events. Further details of this scenario are provided in the description of FIG. 7 which is not repeated herein.

FIG. 2 is a flow diagram illustrating a method for performing object detection using multiple front-facing cameras according to some of the disclosed embodiments.

In step 202, the method can include receiving a first image having a first field of view.

In some implementations, a wide-angle camera sensor is configured to capture a wide field of view image of the area in front of the vehicle. In some embodiments, the wide field of view may cover 120 degrees or more horizontally, enabling the camera to capture a broad view of the road and surrounding environment. In some implementations, this wide-angle image provides situational awareness and context for detecting objects of interest in the vehicle's path, such as other vehicles, pedestrians, road signs, and potential hazards.

In some implementations, the wide-angle camera sensor may utilize a wide-angle lens assembly, such as a fisheye lens, to achieve the large field of view. The wide-angle lens assembly focuses incoming light from the broad scene onto an image sensor, which converts the optical image into a digital format. The image sensor may be a CMOS (Complementary Metal-Oxide Semiconductor) or CCD (Charge-Coupled Device) sensor with a resolution suitable for detecting objects at a distance, such as 1080p or higher. The digital output from the image sensor is then received by the dashcam's processing unit for analysis. In some embodiments, the wide-angle camera sensor may be part of a multi-camera assembly that includes a second near-field camera sensor, as will be discussed in later steps. The two camera sensors may be mounted in close proximity on the vehicle, such as in a side-by-side or stacked configuration, to enable capture of synchronized images from the different fields of view.

In step 204, the method can include inputting the first image to a first machine learning model.

In some implementations, the first machine learning model can be specifically trained to detect objects of interest within the wide field of view image, such as vehicles, license plates, traffic lights, road signs, and other relevant objects.

In some implementations, the first machine learning model may be a neural network (such as CNNs, transformer models, etc.) architecture optimized for efficient object detection in high-resolution images, although the specific model type is not limiting and other models (e.g., transformer-based models, or other models) may be used. The model is pre-trained on a large dataset of annotated wide-angle road scene images to learn hierarchical features that effectively discriminate between different object classes. The training process tunes the model's parameters to minimize detection errors while maintaining real-time performance.

In some implementations, the first machine learning model may comprise several prediction heads coupled to a backbone network in a multi-task network architecture. For example, the backbone may comprise a CNN coupled to a feature pyramid network that can process images at multiple depths before outputting feature vectors to an object detection head. Examples of such a multi-task network are described in commonly-owned U.S. Pat. No. 11,532,169.

In various implementations, an advantage of using a dedicated object detection model for the wide-angle image is computational efficiency. The wide-angle image covers a large spatial area at a lower angular resolution compared to the near-field image that will be processed later in the pipeline. This means that small objects like distant license plates may only occupy a few pixels in the wide-angle image, making them difficult to read directly. However, the first model only needs to detect the presence and coarse location of potential license plates, not read their detailed characters. This initial detection can be performed efficiently using a neural network or deep neural network architecture with a limited number of layers and parameters. By avoiding the need to process the entire wide-angle image at high resolution, the first model can quickly identify regions of interest containing potential license plates for further analysis. Although the specification describes license plate detection, the architecture may be used for detecting other objects (e.g., road signs with or without text, red lights, pedestrians, etc.). In general, the use of a wide-angle camera can be used to perform an initial detection while the second model (discussed next) can be used for further analysis of whatever object is detected first.

As will be discussed, in some implementations, the output of the first model serves as a filtering or gating signal to selectively process regions of interest in the subsequent stages of an ML pipeline. The first model's detections can guide the pipeline to focus computational resources on the most relevant areas of the image, which can be implemented through the sequential flow of data between distinct models.

In step 206, the method can include receiving an object location from the first machine learning model.

In some implementations, the object location can include data such as a list of detected object instances, each associated with a bounding box, a class label, and a confidence score. As used herein, a bounding box refers to a rectangular region defined by the coordinates of its top-left and bottom-right corners, or alternatively by its center coordinates, width, and height. The bounding box encloses the detected object within the image frame, providing its spatial location and extent. The class label is a categorical variable that identifies the type of object detected, such as “vehicle,” “license plate,” “traffic light,” “pedestrian,” etc., based on the predefined classes the model was trained on. A confidence score is a floating-point value between zero and one that indicates the model's estimated probability or confidence that the detected object indeed belongs to the assigned class. A higher confidence score suggests a more reliable detection. The model may also provide additional attributes for each detected object, such as its estimated distance from the camera, depending on the specific implementation and training data.

In step 208, the method can include reading a second image having a second field of view that is time-correlated with the first image.

In some implementations, the second image can comprise a higher-resolution view of a region of interest within the wide-angle frame, enabling more detailed analysis of detected objects. In some implementations, the near-field camera sensor is positioned and oriented to capture a subset of the wide-angle camera's field of view, typically focusing on the central region where objects of interest, such as license plates, are most likely to appear. In some implementations, the two cameras can be synchronized to capture their respective frames at approximately the same time, ensuring that the near-field image corresponds to the same scene as the wide-angle image. In some implementations, an image captured with the second image can include an object that is not present in the first image, and vice-versa. As explained above, in some instances, both images may detect the same object, albeit at different resolutions.

In other implementations, time synchronization between the two cameras may not always be necessary or achievable in practice. For example, in some implementations, the frame rate of the cameras is typically high enough that the time difference between the wide-angle and near-field frames is negligible for most practical purposes. For example, at a frame rate of 30 frames per second, the time difference between consecutive frames is only about 33 milliseconds. During this brief interval, the relative positions of the vehicle and the captured objects are unlikely to change significantly, especially considering the high speed of the AI processing pipeline.

To compensate for any potential time misalignment between the wide-angle and near-field frames, the method may employ a circular buffer or similar data structure to store a short history of the most recent frames from each camera. This allows the system to select the near-field frame that best matches the timestamp of the processed wide-angle frame, even if there is a slight delay between the two. The buffer size can be adjusted based on the expected maximum time difference and the available memory resources.

In step 210, the method can include translating the object location to the second image.

In some implementations, the method can translate the object location to the second image using a pre-computed homography matrix that maps points between the wide-angle and near-field image planes. The homography matrix encodes the geometric relationship between the two camera views, taking into account their relative positions, orientations, and intrinsic parameters (e.g., focal lengths, distortion coefficients). By applying the homography matrix to the coordinates of the bounding box detected in the wide-angle image, the method can estimate the corresponding location of the object in the near-field image. In some implementations, this homography matrix can be estimated offline through a calibration process that involves capturing multiple pairs of wide-angle and near-field images of a known calibration pattern (e.g., a checkerboard) at different positions and orientations. By detecting and matching feature points between the corresponding calibration images, the calibration algorithm can compute the optimal homography matrix that minimizes the reprojection error between the two views. In some implementations, this calibration process needs to be performed only once for a given camera setup, and the resulting homography matrix can be stored and reused for all subsequent translations.

In other implementations, if the camera setup is fixed and the relationship between the wide-angle and near-field views is known a priori (e.g., through mechanical alignment), the translation can be performed using a geometric transformation, such as an affine transformation or a constant offset. In this case, the pre-processing step would involve cropping the relevant region from the near-field image based on the predetermined mapping from the wide-angle coordinates.

By translating the object location from the wide-angle to the near-field view, the method can provide a region of interest (ROI) for the subsequent high-resolution processing stages. This ROI can be used to crop and resize the relevant portion of the near-field image, reducing the computational burden and focusing the analysis on the most informative regions. Furthermore, the translated object location can serve as an initial guess or prior for the second machine learning model, potentially improving its convergence speed and accuracy.

Finally, in some implementations, step 210 may be optional. In such scenarios, the second machine learning model may be able to directly process the entire near-field image and detect the objects of interest without relying on the translated locations from the wide-angle view. However, providing the translated object locations as a pre-processing step can improve the efficiency and robustness of the pipeline, especially in scenarios where the objects of interest are small or sparsely distributed within the high-resolution near-field image.

In step 212, the method can include inputting the second image and the translated object location to a second machine learning model.

In some implementations, the second machine learning model can be specifically designed to process high-resolution images and perform more detailed analysis on the objects of interest, such as license plate recognition via, for example, the detection of alphanumeric characters via optical character recognition. In some implementations, the second machine learning model typically has a similar architecture to the first model but is trained on a dataset of near-field images with annotated object instances. The translated object location from the wide-angle view serves as an additional input to the model, providing a prior or initial guess for the object's position in the near-field image. This prior can help the model to converge faster and more accurately on the object of interest, especially in cases where the object is small or partially occluded. As discussed, other non-license plate detection may be possible. For example, the first machine learning model may detect a traffic light, while the second machine learning model can detect the color of the traffic light. Similarly, the first machine learning model can detect a pedestrian while the second machine learning model can classify the behavior (e.g., walking, running, standing, etc.) of the pedestrian.

In step 214, the method can include receiving a second object location from the second machine learning model.

In some implementations, the output of the second machine learning model is similar in format to the output of the first machine learning model, including a bounding box, class label, and confidence score for each detected object instance. However, in contrast to the first ML model, the second ML model's output is expected to be more precise and detailed than the first ML model's output, due to the higher resolution of the near-field image and the more focused training of the second model. For example, in the case of license plate recognition, the second model may provide the exact coordinates of the license plate characters, along with their predicted text values and recognition confidences.

The refined object location and associated metadata from the second model's output can then be used for further processing, such as tracking the object across multiple frames, updating the vehicle's situational awareness, or triggering specific actions based on the recognized object (e.g., alerting the driver, sending a notification to a remote server).

By leveraging the two-stage pipeline with a wide-angle model for initial object detection and a near-field model for high-resolution analysis, the method can achieve a balance between computational efficiency and recognition accuracy. The first stage quickly identifies potential objects of interest, while the second stage refines the localization and extracts detailed information only for the most relevant regions, saving processing time and resources compared to a brute-force approach of applying the high-resolution model to the entire image.

FIG. 3 is a flow diagram illustrating an alternative method for performing object detection using multiple front-facing cameras according to some of the disclosed embodiments.

In step 302A, the method can include receiving a first image having a first field of view (e.g., wide-angle) and in step 302B, the method can include receiving a second image having a second field of view (e.g., narrow-view). In some implementations, step 302A and step 302B are performed in a manner similar to that described in step 202 and step 208, albeit in a synchronized manner. The description of those steps is not repeated herein.

In step 304A, the method can include inputting the first image to a first machine learning model and in step 304B, the method can include inputting the second image to the first machine learning model. In some implementations, step 304A and step 304B are performed in a manner similar to that described in step 204 and step 212. Notably, however, in the illustrated scenario, in step 304B, the second ML model does not require bounding box or location information and can execute on the full image captured by the second camera. The description of those steps is not repeated herein.

In step 306A, the method can include receiving a first object location and type from the first machine learning model based on the first image and, in step 306B, the method can include receiving a second object location and type from the first machine learning model based on the second image. Generally, the outputs of the models are similar or the same to those described in step 206 and step 214 of FIG. 2 and the description of those steps is not repeated herein.

Although forward-facing cameras are described, the method of FIG. 3 may consider any number of cameras. For example, inward-facing cameras can be used in a fusion model to confirm distracted driving as a combination of inward-captured actions (e.g., mobile usage) and outward activity (e.g., lane changes).

In step 308, the method can include inputting the first object location, first object type, second object location, and second object type into an event model and, in step 310, the method can include predicting an event based on the output of the event model. Then, in step 312, the method can include transmitting or displaying an event notification based on the predicted event.

In some implementations, the event model comprises a fusion ML model, where the outputs from the two parallel branches of the pipeline are combined to generate a more comprehensive understanding of the scene. In some implementations, the event model is a machine learning model that takes as input the locations and types of objects detected in both the wide-angle and near-field views of the scene. By considering information from both views simultaneously, the event model can reason about the spatial and semantic relationships between the detected objects and infer higher-level events or situations that may be occurring.

For example, if the wide-angle view reveals the presence of a pedestrian near the edge of the road, while the near-field view provides a more detailed recognition of the pedestrian's pose and orientation. The event model can combine these pieces of information to infer that the pedestrian is about to step onto the road, which may require the driver's attention or even an automatic braking response from the vehicle.

As another example, the wide-angle view may capture a scene where a vehicle is making a right turn at an intersection. In the background of the image, there is a parked police car with its lights flashing. The object detection model for the wide-angle view identifies the presence of the police car and its rough location within the scene. Meanwhile, the near-field view is focused on the area directly in front of the vehicle, where the license plate of the turning car is clearly visible. The object detection model for the near-field view is able to read the characters on the license plate with high accuracy, providing a detailed identification of the specific vehicle.

The event model takes in the information from both views-the presence and location of the police car from the wide-angle view, and the license plate reading from the near-field view. By combining these pieces of information, the event model can infer a higher-level event, such as “turning vehicle detected with license plate ABC123 in the presence of a police car.”

This event prediction could trigger several possible actions or responses. For example, the system could automatically log the license plate number and timestamp of the event, along with a snapshot of the scene from both camera views. This information could be valuable for later reference or analysis, especially if the police car's presence suggests a potential traffic violation or incident. The system could also compare the detected license plate against a database of known or suspected vehicles of interest, such as stolen cars or vehicles associated with amber alerts. If a match is found, the event model could immediately notify the relevant authorities or take appropriate action to assist in the situation. The system could also provide a real-time alert to the driver, informing them of the presence of the police car and reminding them to drive cautiously and comply with all traffic laws. In another scenario, the event model's output could be combined with other sensor data from the vehicle (e.g., speed, acceleration, steering angle) to assess whether the turning maneuver was performed safely and legally. If any anomalies are detected, the system could provide feedback to the driver or even take corrective action autonomously.

The architecture of the event model may vary depending on the specific application and the complexity of the events being detected. In some implementations, the event model can comprise a recurrent neural network (RNN) or a long short-term memory (LSTM) network to process the sequence of object locations and types from both views over time. These types of models can learn to capture temporal dependencies and patterns in the data, allowing them to reason about the evolution of the scene and detect events that unfold over multiple frames.

In another implementation, the event model can comprise a graph neural network (GNN) to model the spatial relationships between the detected objects. In this case, each object would be represented as a node in a graph, with edges connecting objects that are spatially close or semantically related. The GNN can then learn to propagate information across the graph and identify patterns or configurations that correspond to specific events.

In some implementations, the event mode can be trained on a large dataset of annotated driving scenes and thus can learn to recognize a wide range of events and situations that are relevant for vehicle safety and driver assistance. These may include common events like lane changes, merges, and turns, as well as more complex scenarios like pedestrians crossing the road, vehicles running red lights, or accidents and collisions. Once trained, the event model can be integrated into the overall perception pipeline of the vehicle, taking in the real-time outputs of the wide-angle and near-field object detection models and generating event predictions on the fly. These predictions can then be used to alert the driver, trigger automatic safety responses, or inform higher-level decision-making systems in the vehicle.

Overall, the fusion of information from multiple camera views through an event model is a powerful approach for enhancing the situational awareness and decision-making capabilities of intelligent vehicles. By leveraging the complementary strengths of wide-angle and near-field perception, this approach can help to build a more complete and nuanced understanding of the complex and dynamic environments in which vehicles operate.

Notably, in both FIGS. 2 and 3, image detection and event detection can further be combined with telematics data (e.g., vehicle speed) as well as non-image sensor data (e.g., GPS readings, accelerometer, inertial measurement unit, and other similar data) or third-party vehicle data to improve predictions or event detections as well as detect more complex events.

While the previous descriptions focus primarily on object detection, it should be understood that the machine learning models employed in the present system are capable of, and may be used for, a much broader range of tasks. These tasks can include, but are not limited to: semantic segmentation for identifying backgrounds and other semantically consistent image segments such as sky or drivable regions; attribute detection for capturing various properties of detected objects or regions; generating textual descriptions of scenes or objects to enable future integration with large language models (LLMs); and modeling relationships between objects or elements in the scene to facilitate future symbolic reasoning. For instance, the system may not only detect a vehicle, but also segment the road it's driving on, identify attributes like its color and speed, generate a textual description of its behavior, and model its relationship to other vehicles or road elements. This expansive capability allows the system to build a rich, multi-modal understanding of the environment, which can be leveraged for advanced decision-making processes and future AI integrations. Moreover, this flexibility in the machine learning models'applications ensures that the system can be readily adapted to incorporate emerging AI technologies and methodologies as they become available, without requiring fundamental changes to the underlying hardware or software architecture.

FIG. 4 is a flow diagram illustrating a method for utilizing a network of dashcams to locate vehicles or persons of interest and track historical vehicle locations according to some of the disclosed embodiments.

In step 402, the method can include receiving an alert notification, such as an Amber Alert, containing information about a vehicle or person of interest, including a license plate number. The alert notification may be received by a central server that manages the network of connected dashcams. The alert notification may originate from law enforcement agencies, government entities, or other authorized sources.

In step 404, the method can include broadcasting the alert notification and the license plate number to a network of connected dashcams installed within vehicles. The central server can distribute the alert notification to all dashcams in the network, or to a subset of dashcams based on their location, proximity to the last known location of the vehicle of interest, or other relevant factors. The dashcams can receive the alert notification via their wireless network interface, as described in FIG. 1.

In step 406, the method can include each dashcam in the network processing the received alert notification and compare the license plate number to license plates detected in their captured video footage. The dashcams can utilize the methods described in FIGS. 2 and 3 to detect and recognize license plates in real-time as they capture video footage. Specifically, the dashcams can leverage their dual forward-facing camera sensors, one with a wide field of view and one with a narrow field of view, to accurately detect and read license plates even in challenging conditions.

In step 408, if the method detects a match between the license plate number from the alert and a license plate in its captured footage, the method can proceed to step 410. The dashcam can compare the license plate number from the alert to the recognized license plate text extracted from the video footage using the methods of FIGS. 2 and 3. If a match is found, indicating that the vehicle of interest has been spotted, the method can proceed to step 410. Otherwise, the method can return to step 406 to continue monitoring for a match, allowing the dashcam to process newly captured video footage in real-time.

In step 410, the method can include the dashcam transmitting a notification to a central server, including the location, timestamp, and relevant video footage of the detected match. In some implementations, the dashcam can package the key information about the detected match, such as the GPS coordinates of the dashcam at the time of the detection, the timestamp of the video footage containing the match, and the relevant portion of the video footage itself. This information can be transmitted to the central server via the dashcam's wireless network interface, using either a cellular connection or a dedicated communication channel.

In step 412, the method can include the central server aggregating the information received from multiple dashcams to track the historical locations of the vehicle of interest over time. As multiple dashcams in the network detect and report matches for the same vehicle of interest, the central server can compile a timeline and map of the vehicle's movements. This can be done by sorting the received notifications by timestamp and extracting the location information from each notification. The central server can then construct a historical record of the vehicle's path, allowing authorities to track its movements and potentially predict its future location. In some implementations, an individual dashcam can perform step 412 when networked with other dashcams, or when receiving aggregated data generally.

In step 414, the method can include the central server providing the location information and video evidence to the relevant authorities to aid in the search for the vehicle or person of interest. In some implementations, the central server can package the aggregated location timeline, along with the associated video footage from multiple dashcams, into a comprehensive report. In some implementations, this report can be securely transmitted to the appropriate law enforcement agencies or government entities, providing them with critical information and evidence to support their search efforts. In some implementations, the video footage can serve as valuable evidence, corroborating the location timeline and providing visual confirmation of the vehicle and potentially its occupants.

FIG. 5 is a flow diagram illustrating a method for leveraging an interconnected dashcam network to expand situational awareness and context around events of interest according to some of the disclosed embodiments.

In step 502, the method can include detecting an event of interest, such as a traffic accident, using a first dashcam installed within a vehicle. In some implementations, the dashcam can continuously monitor the vehicle's surroundings using its array of cameras and sensors, as described in FIG. 1. The event detection can be triggered by a sudden change in the vehicle's motion, such as rapid deceleration or impact, detected by the dashcam's accelerometer or gyroscope. Alternatively, or in conjunction with the foregoing, vehicle sensors can be used as a source of sensor or telematics data. Alternatively, the event can be detected through analysis of the video footage, using computer vision techniques to identify collisions, near-misses, or other relevant incidents.

In step 504, the method can include determining if the first dashcam captured sufficient detail of the event to provide context for further processing. In some implementations, the dashcam can analyze the captured video footage and sensor data to assess the quality and completeness of the information. In some implementations, factors such as the camera's field of view, the lighting conditions, any obstructions or occlusions, and the duration of the event can be considered. If the dashcam determines that its captured data provides a clear and comprehensive view of the event, In some implementations, it can flag the footage as sufficient for further analysis.

In step 506, if the first dashcam did not capture sufficient detail, the method can proceed to step 508. For example, this can occur if the dashcam's view of the event was partially blocked, if the event occurred outside the camera's field of view, if the dashcam was damaged or malfunctioned during the event, etc. In such cases, relying solely on the first dashcam's footage may not provide a complete understanding of the incident. The method can then attempt to gather additional information from other dashcams in the network. Otherwise, if the first dashcam's footage is deemed sufficient, the method may end or otherwise transmit event details (discussed herein), as no further data collection is necessary.

In step 508, the method can include identifying other dashcams in the network that were in the geographic vicinity of the event at the time it occurred. In some implementations, the first dashcam can communicate with a central server, providing the timestamp and location of the detected event. In some implementations, the central server can then query its database of connected dashcams to identify those that were active and within a certain radius of the event's location during the relevant time window. In some implementations, this can be done using the GPS coordinates and timestamps reported by each dashcam, allowing the server to triangulate which devices were in the proximity of the incident. In other implementations, the method can query a mesh network of dashcams which can then directly provide their footage (described next).

In step 510, the method can include querying the identified dashcams for any relevant footage they may have captured of the event. In some implementations, the central server can send a request to each of the identified dashcams, specifying the timestamp and location of the event of interest. Alternatively, in a mesh network, the method can query nearby dashcams directly. In some implementations, the dashcams can then search their local storage for any video footage or sensor data that matches the specified criteria. If relevant footage is found, the dashcams can transmit it back to the central server (or mesh networked requesting dashcam) for further analysis.

In step 512, the method can include receiving and aggregating the relevant footage from the queried dashcams. As the queried dashcams respond with their captured data, the central server (or requesting dashcam in a mesh network) can collect and organize the footage based on factors such as the timestamp, location, and quality of the data. The server (or requesting dashcam in a mesh network) can then stitch together the various angles and perspectives provided by multiple dashcams to create a composite view of the event. In some implementations, this can involve synchronizing the footage based on the timestamps and using computer vision techniques to align and blend the different viewpoints into a cohesive representation.

In step 514, the method can include transmitting the aggregated footage to third parties (e.g., insurance companies or accident investigators) to enhance their understanding of the event and context. In some implementations, the central server (or requesting dashcam in a mesh network) can compile the aggregated footage into a comprehensive report, along with any relevant metadata such as the timestamp, location, and vehicle information associated with each dashcam. In some implementations, this report can be securely shared with authorized parties, such as insurance adjusters or law enforcement personnel, to aid in their investigation of the incident. The aggregated footage can provide a more complete and objective account of the event, helping to establish fault, assess damages, and support insurance claims or legal proceedings.

FIG. 6 is a diagram illustrating the combination of wide and narrow field of view video streams into a single composite view to enhance the user experience when reviewing captured footage according to some of the disclosed embodiments.

In step 602, the method can include capturing video footage using a wide field of view camera and a narrow field of view camera simultaneously. In some implementations, the wide field of view camera captures a broader perspective of the scene, providing context and situational awareness, while the narrow field of view camera captures high-resolution details of specific regions of interest. In some implementations, the two cameras are synchronized to ensure that their footage is properly aligned in time. Details of capturing such footage are described in the description of FIGS. 2 and 3 and not repeated herein.

In step 604, the method can include stitching together the wide field of view video footage to create a panoramic video stream. The stitching process involves analyzing the overlapping regions between consecutive frames of the wide field of view footage and using computer vision techniques to align and blending them seamlessly. In some implementations, this creates a continuous, wide-angle view of the scene, providing a comprehensive context for the viewer. The stitching can be performed in real-time as the footage is captured, or as a post-processing step after the footage has been stored.

In step 606, the method can include identifying regions of interest within the wide field of view video stream where high-resolution details are desired. In some implementations, this can be based on user preferences, predefined criteria, or automated analysis of the scene. For example, the system may prioritize regions containing license plates, faces, or road signs for high-resolution enhancement. The identification of regions of interest can be performed using computer vision techniques, such as object detection or semantic segmentation, to locate and classify relevant elements within the wide field of view footage.

In step 608, the method can include extracting the corresponding high-resolution regions from the narrow field of view video stream. Based on the identified regions of interest in the wide field of view footage, in some implementations, the method can map these regions to the corresponding areas in the narrow field of view footage. In some implementations, this mapping can be performed using the known spatial relationship between the two cameras, as well as any calibration data that describes their relative positions and orientations. In some implementations, the high-resolution regions are then cropped from the narrow field of view footage, preserving the maximum level of detail available.

In step 610, the method can include overlaying the extracted high-resolution regions onto the panoramic video stream as inset windows. In some implementations, the method can position the high-resolution insets at the corresponding locations within the wide-angle panorama, creating a composite view that combines the broad context with localized detail. Details of converting a position of a high resolution image to a position within a wide view image, and vice versa, have been described previously and are not repeated herein. In some implementations, the insets can be displayed as picture-in-picture windows, or seamlessly blended into the panorama using image stitching techniques. In some implementations, the size and position of the insets can be adjusted based on user preferences or the relative importance of each region of interest.

In step 612, the method can include displaying the composite video stream, which combines the wide field of view context with high-resolution details, to the user for enhanced viewing experience. Such a “foveated rendering” approach allows the user to appreciate both the overall situational awareness provided by the wide-angle view and the fine details captured by the narrow field of view camera. The user can view the composite stream on a display device, such as a smartphone, tablet, or computer monitor, and interact with the playback controls to pause, rewind, or zoom in on specific areas of interest. The composite view provides a more immersive and informative representation of the captured scene, enabling users to better understand and analyze the events recorded by the dashcam system.

FIG. 7 is a flow diagram illustrating a method for utilizing the dashcam system to provide analytics and real-time monitoring for fleet management applications according to some of the disclosed embodiments.

In step 702, the method can include collecting video footage and sensor data from the dashcams installed in a fleet of vehicles. The dashcams capture video footage using their multiple cameras, including inward-facing and outward-facing cameras, as described in FIGS. 1 through 3. In addition to video, the dashcams or peripheral devices such as gateway devices can also collect data from various sensors, such as GPS for location tracking, accelerometers and gyroscopes for motion and orientation sensing, and OBD-II (On-Board Diagnostics) sensors for vehicle performance metrics. These sensors provide valuable context and insights beyond what is visible in the video footage alone.

In step 704, the method can include analyzing the video footage from the inward-facing cameras to monitor driver attentiveness and behavior. In some implementations, the method can use computer vision techniques, such as facial landmark detection and eye tracking, to assess the driver's gaze direction, blink rate, and head pose as described in FIG. 1. These metrics can be used to infer the driver's level of alertness and detect any signs of distraction or fatigue. Additionally, the method can analyze the driver's facial expressions and body language to identify any signs of stress, aggression, or other emotional states that may impact their driving performance.

In step 706, the method can include analyzing the video footage from the outward-facing cameras and sensor data to track route adherence and driving patterns. In some implementations, the method can use GPS data to compare the vehicle's actual route against the planned or assigned route, and identify any deviations or unauthorized stops. In some implementations, the video footage can then be analyzed to detect road signs, traffic signals, and other landmarks, which can be cross-referenced with the GPS data to verify the vehicle's location and path. In some implementations, the accelerometer and gyroscope data can be used to detect sudden acceleration, hard braking, or aggressive steering maneuvers, which may indicate unsafe or inefficient driving patterns. In some implementations, OBD-II data, such as fuel consumption and engine RPM, can also be analyzed to assess the driver's efficiency and adherence to eco-driving practices.

In step 708, the method can include detecting any unauthorized usage or suspicious after-hours activity of fleet vehicles based on license plate detection events. In some implementations, the method can use the outward-facing cameras to capture license plate information of the fleet vehicles, and compare it against the expected or authorized usage schedules. If a vehicle is detected in use outside of its designated hours or location, the method can flag it as a potential unauthorized usage. Additionally, the method can monitor for any suspicious activities, such as vehicles entering or exiting the fleet yard during off-hours, or vehicles making unexpected stops or detours.

In step 710, if any issues or anomalies are detected in steps 704, 706, or 708, the method can proceed to step 712. In some implementations, the method can compare the analyzed data against predefined thresholds or patterns to identify any deviations or potential concerns. For example, if a driver's blink rate falls below a certain threshold, it may indicate fatigue and trigger an alert. Similarly, if a vehicle's route deviates from the planned path by more than a specified distance, it may be flagged as a route adherence issue. If no issues or anomalies are detected, the method can return to step 702 to continue monitoring the fleet in real-time.

In step 712, the method can include generating alerts or notifications for the fleet manager regarding the detected issues or anomalies. In some implementations, the alerts can be delivered through various channels, such as SMS, email, or push notifications on a fleet management dashboard. In some implementations, the alerts can include relevant details about the issue, such as the specific vehicle and driver involved, the time and location of the incident, and the severity or priority level of the issue. In some implementations, the fleet manager can use these alerts to quickly identify and address any potential problems or inefficiencies in their operations.

In step 714, the method can include providing the fleet manager with access to the relevant video footage and analytics to help them address the identified issues and optimize fleet performance. In some implementations, the method can compile the video footage, sensor data, and analyzed metrics into comprehensive reports and visualizations that the fleet manager can access through a web-based portal or mobile app. These tools allow the fleet manager to drill down into specific incidents, review the associated video footage and sensor data, and gain a detailed understanding of the context and causes of each issue.

FIG. 8 is a flow diagram illustrating a method for processing voice commands in a dashcam system according to some of the disclosed embodiments.

In step 802, the method can include capturing audio data using a microphone integrated into the dashcam system. In some implementations, the microphone can comprise an omnidirectional microphone embedded within the dashcam system.

In step 804, the method can include applying a noise cancellation model to the captured audio data to remove background noise and isolate the driver's voice. In some implementations, the noise cancellation model may comprise a bandpass filter or similar filter. In other implementations, the noise cancellation model can be a neural network, such as a CNN or an RNN, trained on a large dataset of vehicle cabin audio recordings with various noise conditions. In some implementations, the model learns to identify and separate the driver's voice from the background noise, which can include engine sounds, road noise, wind noise, and other environmental factors. By applying the noise cancellation model, the system can obtain a clean, isolated voice signal for further processing.

In step 806, the method can include processing the noise-cancelled audio data using a voice command detection model to identify any spoken commands or keywords. The voice command detection model can be a machine learning model, such as a DNN or a hidden Markov model (HMM), trained on a dataset of voice commands and keywords relevant to the dashcam system's functionality. The model analyzes the audio signal to detect the presence of any predefined commands, such as “start recording,” “stop recording,” “save video,” or “send alert.” In some implementations, customized verbal commands can be specified by a user. The voice command detection model can be speaker-independent, meaning it can recognize commands from any user without prior training, or it can be speaker-dependent, utilizing a brief training phase to adapt to the specific user's voice.

In step 808, the method can include comparing any detected voice commands or keywords against a customizable mapping of commands to actions. The mapping defines the specific actions or functions that should be triggered by each recognized command. For example, the command “start recording” may be mapped to the action of initiating video recording on the dashcam, while the command “send alert” may be mapped to the action of transmitting an emergency alert to a designated contact or authorities. The mapping can be pre-configured with a default set of commands and actions, but it can also be customized by the user to add, modify, or remove commands and their associated actions based on their preferences and needs.

In step 810, if a detected voice command matches an entry in the command-to-action mapping, the method proceeds to step 812. If no matching command is found, the method returns to step 802 to continue monitoring for voice commands.

In step 812, the method can include executing the action or function associated with the detected voice command, as defined in the command-to-action mapping. This can involve triggering various components or subsystems of the dashcam, such as starting or stopping video recording, capturing still images, activating or deactivating sensors, or transmitting data to external services or devices. The specific actions executed in this step may depend on the user's customized mapping and the particular command detected.

FIG. 9 is a flow diagram illustrating a method for processing gesture commands in a dashcam system using a gesture recognition model according to some of the disclosed embodiments.

In step 902, the method can include capturing video data using an inward-facing camera integrated into the dashcam system. The inward-facing camera is positioned to capture the driver's movements and gestures within the vehicle's cabin. Details of the inward-facing camera were provided in the description of FIG. 1 and are not repeated herein.

In step 904, the method can include processing the captured video data using a gesture recognition model to identify any predefined gestures performed by the driver. The gesture recognition model can be a machine learning model, such as a CNN, RNN, another neural network or speech model, trained on a dataset of video sequences depicting various gestures relevant to the dashcam system's functionality. The model analyzes the video frames to detect and classify the driver's hand and body movements into specific gesture categories, such as “start recording,” “stop recording,” “save video,” or “mute audio.” The gesture recognition model can be trained to recognize a set of universal gestures that are intuitive and easy for drivers to perform without taking their eyes off the road. Details of the inward-facing model were provided in the description of FIG. 1 and are not repeated herein.

In step 906, the method can include comparing any detected gestures against a customizable mapping of gestures to actions. Similar to the voice command mapping in FIG. 8, the gesture mapping defines the specific actions or functions that should be triggered by each recognized gesture. For example, the gesture of pointing at the dashcam may be mapped to the action of starting video recording, while the gesture of waving a hand in front of the camera may be mapped to the action of stopping the recording. The mapping can be pre-configured with a default set of gestures and actions, but it can also be customized by the user to add, modify, or remove gestures and their associated actions based on their preferences and needs.

In step 908, if a detected gesture matches an entry in the gesture-to-action mapping, the method proceeds to step 910. If no matching gesture is found, the method returns to step 902 to continue monitoring for new gestures.

In step 910, the method can include performing a safety check using the outward-facing cameras before executing the action associated with the detected gesture. The purpose of the safety check is to ensure that the requested action does not interfere with the driver's ability to safely operate the vehicle. The system can analyze the video data from the outward-facing cameras (using one or more of the near or wide-angle models) and telematics data to assess the current driving conditions, such as the vehicle's speed, the proximity of other vehicles or obstacles, and the presence of any potential hazards. If the safety check determines that executing the action would not pose a risk to the driver or other road users, the method proceeds to step 912. If the safety check identifies a potential risk, the method can either abort the action and return to step 902, or it can delay the execution of the action until the driving conditions become safer.

In step 912, the method can include executing the action or function associated with the detected gesture, as defined in the gesture-to-action mapping. This can involve triggering various components or subsystems of the dashcam, such as starting or stopping video recording, capturing still images, activating or deactivating sensors, or adjusting the dashcam's settings. The specific actions executed in this step will depend on the user's customized mapping and the particular gesture detected. After executing the associated action, the method can return to step 902 to continue monitoring for new gestures, allowing the user to interact with the dashcam system using intuitive and hands-free commands while ensuring that the actions do not compromise their safety while driving.

FIG. 10 is a flow diagram illustrating a method for enabling communication and collaboration between multiple dashcam systems using a mesh network according to some of the disclosed embodiments.

In step 1002, the method can include configuring each dashcam system in a fleet of vehicles to establish a direct wireless connection with nearby dashcam systems using a standard wireless communication protocol, such as IEEE 802.11s, Wi-Fi Aware, or similar protocols. These protocols support the creation of decentralized mesh networks, allowing devices to communicate directly with each other without relying on a central access point or server.

In step 1004, the method can include discovering and connecting to nearby dashcam systems to form a mesh network. In some implementations, each dashcam system can broadcast its presence and search for other compatible devices within its wireless range. In some implementations, when two or more dashcam systems detect each other, they can establish a direct peer-to-peer connection and exchange information about their capabilities, status, and available resources. As more dashcam systems join the network, they can dynamically route data through the mesh, enabling communication between devices that may not be in direct range of each other.

In step 1006, the method can include sharing data and collaborating with other dashcam systems in the mesh network to enable various features and applications described in the previous figures, without relying on a central server. For example, dashcam systems can share real-time alerts about road hazards, accidents, or traffic conditions (as described in FIG. 5), allowing other vehicles in the network to take appropriate actions or adjust their routes. Dashcam systems can also share license plate data and video footage to assist in locating vehicles or persons of interest (as described in FIG. 4), enabling a decentralized and privacy-preserving approach to collaborative surveillance. Additionally, dashcam systems can distribute updates, configurations, or machine learning models across the mesh network, allowing for efficient and scalable deployment of new features and improvements.

In step 1008, the method can include processing and analyzing data locally on each dashcam system, leveraging the edge computing capabilities of the devices. By performing tasks such as video analysis, object detection, and data aggregation on the dashcam systems themselves (as described in FIGS. 2, 3, and 7), the mesh network can reduce the bandwidth and latency requirements for communicating with a central server. This allows for faster response times, improved privacy, and greater resilience to network disruptions or server outages.

In step 1010, the method can include synchronizing data and insights from the mesh network with a central server or cloud platform when a connection is available. While the mesh network enables the dashcam systems to operate independently, there may still be benefits to periodically uploading data to a central repository for long-term storage, analysis, or integration with other systems. The dashcam systems can opportunistically connect to the server when a stable connection is available, such as when a vehicle returns to its home base, truck stop, or encounters a Wi-Fi hotspot. During the synchronization process, the dashcam systems can upload relevant data, such as aggregated metrics, event logs, or selected video clips, and download any necessary updates or configurations from the server.

By leveraging mesh networking, the dashcam system can enable a more resilient, adaptable, and collaborative approach to fleet management and road safety. The ability to communicate and operate independently of a central server allows the dashcam systems to continue functioning in areas with limited connectivity, share information and resources with nearby vehicles, and make real-time decisions based on local context and conditions. At the same time, the option to synchronize with a central server provides a means for long-term data aggregation, analysis, and system management, combining the benefits of edge computing and cloud-based services.

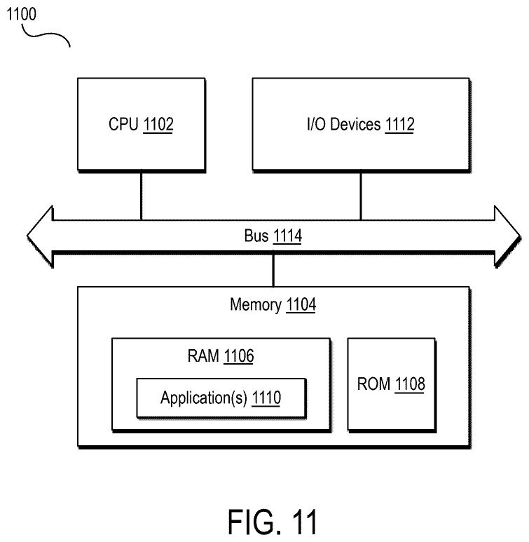

FIG. 11 is a block diagram of a computing device according to some embodiments of the disclosure.

As illustrated, the device 1100 includes a processor or central processing unit (CPU) such as CPU 1102 in communication with a memory 1104 via a bus 1114. The device also includes one or more input/output (I/O) or peripheral devices 1112. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1102 may comprise a general-purpose CPU. The CPU 1102 may comprise a single-core or multiple-core CPU. The CPU 1102 may comprise a system-on-a-chip (SoC) or a similar embedded system. In some embodiments, a graphics processing unit (GPU) may be used in place of, or in combination with, a CPU 1102. Memory 1104 may comprise a memory system including a dynamic random-access memory (DRAM), static random-access memory (SRAM), Flash (e.g., NAND Flash), or combinations thereof. In one embodiment, the bus 1114 may comprise a Peripheral Component Interconnect Express (PCIe) bus. In some embodiments, the bus 1114 may comprise multiple busses instead of a single bus.

Memory 1104 illustrates an example of a non-transitory computer storage media for the storage of information such as computer-readable instructions, data structures, program modules, or other data. Memory 1104 can store a basic input/output system (BIOS) in read-only memory (ROM), such as ROM 1108 for controlling the low-level operation of the device. The memory can also store an operating system in random-access memory (RAM) for controlling the operation of the device.

Applications 1110 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 1106 by CPU 1102. CPU 1102 may then read the software or data from RAM 1106, process them, and store them in RAM 1106 again.

The device may optionally communicate with a base station (not shown) or directly with another computing device. One or more network interfaces in peripheral devices 1112 are sometimes referred to as a transceiver, transceiving device, or network interface card (NIC).

An audio interface in peripheral devices 1112 produces and receives audio signals such as the sound of a human voice. For example, an audio interface may be coupled to a speaker and microphone (not shown) to enable telecommunication with others or generate an audio acknowledgment for some action. Displays in peripheral devices 1112 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1112 may comprise any input device arranged to receive input from a user. An illuminator in peripheral devices 1112 may provide a status indication or provide light. The device can also comprise an input/output interface in peripheral devices 1112 for communication with external devices, using communication technologies, such as USB, infrared, Bluetooth®, or the like. A haptic interface in peripheral devices 1112 provides tactile feedback to a user of the client device.

A GPS receiver in peripheral devices 1112 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,”“ ” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

1. A system comprising:
a first camera sensor, the first camera sensor capturing a wide-field of view in front of a vehicle;
a second camera sensor, the second camera sensor capturing a near-field of view in front of the vehicle, wherein the first camera sensor and the second camera sensor are configured to simultaneously record images in front of the vehicle;
a controller, the controller including:
a processing unit,
a plurality of machine learning models, wherein a first machine learning model in the plurality of machine learning models is configured to receive a first image frame from the first camera sensor and detect a first detection of a first object within the first image frame, and wherein a second machine learning model in the plurality of machine learning models is configured to receive a second image frame from the second camera sensor and detect a second detection of a second object within the second image frame, and
a machine learning pipeline configured to receive the first detection and the second detection and transmit an instruction to the processing unit based on the first detection and second detection.

2. The system of claim 1, wherein the first detection of the first object comprises a detection of a license plate.

3. The system of claim 2, wherein the second detection of the second object comprises an identification of alphanumeric characters on the license plate.

4. The system of claim 1, wherein the first machine learning model and the second machine learning model are executed independently.

5. The system of claim 1, wherein the machine learning pipeline is configured to execute the second machine learning model after detecting the first detection.

6. The system of claim 5, wherein the machine learning pipeline is configured to provide location information to the second machine learning model when providing the second image frame to the second machine learning model.

7. The system of claim 1, wherein the machine learning pipeline is configured to input the first detection and second detection into a third machine learning model to detect an event.

8. The system of claim 1, further comprising an inward-facing camera communicatively coupled to the controller, wherein the controller is configured to execute an inward machine learning model, the inward machine learning model configured to receive third image frames from the inward-facing camera and detect a gesture occurring within the third image frames, wherein the controller is configured to transmit a second instruction to the processing unit based on a type of the gesture.

9. The system of claim 1, further comprising a microphone configured to record audio samples within the vehicle, wherein the controller is configured to execute voice model to reduce noise within the audio samples and detect a spoken command within the audio samples, wherein the controller is configured to transmit a third instruction to the processing unit based on the spoken command.

10. The system of claim 1, further comprising a wireless network interface, wherein the controller is configured to establish a mesh network with at least one other dashcam using the wireless network interface.

11. A method comprising:
receiving, at a first machine learning model, a first image frame from a first camera sensor, the first camera sensor capturing a wide-field of view in front of a vehicle;
receiving, at a second machine learning model, a second image frame from a second camera sensor, the second camera sensor capturing a near-field of view in front of the vehicle, wherein the first image frame and the second image frame are captured simultaneously;
detecting, using the first machine learning model, a first object within the first image frame;
detecting, using the second machine learning model, a second object within the second image frame; and
transmitting, using a machine learning pipeline, an instruction to a processing unit based on detecting the first object and the second object.

12. The method of claim 11, wherein detecting the first object comprises detecting a license plate within the first image frame, and wherein detecting the second object comprises identifying alphanumeric characters on the license plate within the second image frame.

13. The method of claim 11, further comprising executing the first machine learning model and the second machine learning model independently; and executing, using the machine learning pipeline, the second machine learning model after detecting the first object within the first image frame.

14. The method of claim 13, further comprising providing, using the machine learning pipeline, location information of the first object to the second machine learning model when providing the second image frame to the second machine learning model.

15. The method of claim 11, further comprising inputting, using the machine learning pipeline, a detection of the first object and a detection of the second object into a third machine learning model; and detecting, using the third machine learning model, an event based on the detection of the first object and the detection of the second object.

16. A non-transitory computer-readable storage medium for tangibly storing computer program instructions capable of being executed by a computer processor, the computer program instructions defining steps of:
receiving, at a first machine learning model, a first image frame from a first camera sensor, the first camera sensor capturing a wide-field of view in front of a vehicle;
receiving, at a second machine learning model, a second image frame from a second camera sensor, the second camera sensor capturing a near-field of view in front of the vehicle, wherein the first image frame and the second image frame are captured simultaneously;
detecting, using the first machine learning model, a first object within the first image frame;
detecting, using the second machine learning model, a second object within the second image frame; and
transmitting, using a machine learning pipeline, an instruction to a processing unit based on detecting the first object and the second object.

17. The non-transitory computer-readable storage medium of claim 16, wherein detecting the first object comprises detecting a license plate within the first image frame, and wherein detecting the second object comprises identifying alphanumeric characters on the license plate within the second image frame.

18. The non-transitory computer-readable storage medium of claim 16, further comprising executing the first machine learning model and the second machine learning model independently; and executing, using the machine learning pipeline, the second machine learning model after detecting the first object within the first image frame.

19. The non-transitory computer-readable storage medium of claim 18, further comprising providing, using the machine learning pipeline, location information of the first object to the second machine learning model when providing the second image frame to the second machine learning model.

20. The non-transitory computer-readable storage medium of claim 16, further comprising inputting, using the machine learning pipeline, a detection of the first object and a detection of the second object into a third machine learning model; and detecting, using the third machine learning model, an event based on the detection of the first object and the detection of the second object.
